(19) United States
(12) Patent Application Publication
(10) Pub. No.: US 2006/0043788 A1
(43) Pub. Date: Mar. 2, 2006

(54) Braking force generator for a hydraulic vehicle brake system and vehicle brake system

(76) Inventor: Peter Schluter, Kammerforst (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/214,250

(22) Filed: Aug. 29, 2005

(30) Foreign Application Priority Data
Aug. 30, 2004 (DE) 10 2004 041 924.8

(51) Int. Cl. B60T 8/34

(52) U.S. Cl. 303/113.4; 303/115.1

(57) ABSTRACT

The invention relates to a braking-force generator for a hydraulic vehicle braking system, comprising a force input element which can be coupled, or is coupled, to a brake pedal and is displaceable in a basic casing of the braking-force generator, a master brake cylinder, in which a primary piston is displaceably guided, the primary piston delimiting, with the master brake cylinder, a primary pressure chamber for generating a hydraulic braking pressure, a pedal-counterforce simulation means that can be coupled to the force input element, a pedal-actuation detection means for detecting a pedal actuation, and an actuating-force generation means for exerting an actuating force on the primary piston. In the case of this braking-force generator, provision is made whereby the pedal-counterforce simulation means can be coupled to the force input element via a hydraulic system, the hydraulic system being realized with a throttle valve which is provided in the hydraulic connection to the pedal-counterforce simulation means and can be optionally switched into different throttle valve positions.

### CROSS-REFERENCE TO RELATED APPLICATIONS

This application claims priority to German Patent Application No. 10 2004 041 924.8 filed Aug. 30, 2004, the disclosures of which are incorporated herein by reference.

### BACKGROUND OF THE INVENTION

The present invention relates to a braking-force generator for a hydraulic vehicle braking system, comprising a force input element which can be coupled, or is coupled, to a brake pedal and is displaceable in a basic casing of the braking-force generator, a master brake cylinder, in which a primary piston is displaceably guided, the primary piston delimiting, with the master brake cylinder, a primary pressure chamber for generating a hydraulic braking pressure, a pedal-counterforce simulation means that can be coupled to the force input element, a pedal-actuation detection means for detecting a pedal actuation, and an actuating-force generation means for exerting an actuating force on the primary piston.

In the case of currently common braking systems, the hydraulic braking pressure necessary for loading of the wheel brake on the vehicle is generated, predominantly, by means of a master brake cylinder. This requires an actuating force to be applied to the said master brake cylinder, which actuating force is generated in response to an actuation of the brake pedal by the vehicle driver. In order to improve the actuation comfort, the actual brake-pedal force is usually increased by a predetermined percentage by means of a brake booster, enabling the necessary brake-pedal actuating forces for a desired vehicle deceleration to be kept sufficiently small to permit adequate braking of the vehicle by any driver without exertion. Such a braking system having a brake booster is known, for example, from DE 44 05 092, and corresponding U.S. Pat. No. 5,493,946, both of which are incorporated by reference herein.

A disadvantage of these braking systems is that, through his actuating action on the brake pedal, the driver influences the hydraulic pressure on the wheel brakes in each case. This is unproblematic as long as this supports the braking situation. As soon as the driver reacts incorrectly to the actual braking situation, however, for example by injecting too much or too little braking pressure, the braking behaviour, particularly the brake travel and the directional stability, of the vehicle may be impaired, which, in the worst case, may result in an accident.

Nowadays, modern vehicle feedback-control systems (ABS, ESP, TC, etc.) are capable of using the instantaneous drive status of the vehicle to determine the optimum braking power required in the physical limits, and of thus optimising a braking operation. This, however, requires that the aforementioned direct influence of the driver on the braking pressure be prevented. Furthermore, it is now also considered to be a matter of discomfort if the driver is aware of the action of the vehicle feedback-control system on the brake pedal, such as, for example, a repeated vibration on the brake pedal upon activation of the ABS.

In order to take account of these requirements associated with vehicle feedback-control systems, in the case of modern braking systems the brake pedal is already decoupled from the braking-force generation, the actuation of the brake pedal then serving only to detect the deceleration intention of the driver. The actual braking-force generation, for example for actuation of the master brake cylinder, is then effected by a separate braking-force generator, and is even then based only on control data of an electronic controller. It can thereby be checked in advance whether, for example, the desired vehicle deceleration would not exceed the instantaneously pertaining physical limits, in respect of brake travel and directional stability, determined by the vehicle feedback-control systems (ABS, ESP, TC, etc.). At the same time, obviously, the injection of an insufficient deceleration by the driver can also be compensated by the controller, through the injection of a greater braking pressure in order to minimize the stopping distance in emergency situations. Such a system is described, for example, in the prior art, of the generic type, according to EP 1 070 006, and corresponding U.S. Pat. No. 6,494,546, both of which are incorporated by reference herein. It has been found, however, that the production of such braking systems is relatively cost-intensive and that they require the application of a substantial amount of equipment in order that reliable braking operation can be guaranteed even in the event of failure of the braking-force generation means. A further disadvantage of such systems is that, in the case of emergency operation, in which the braking-force generation fails, they have a relatively large idle motion until the braking system exhibits any braking action resulting from a direct mechanical coupling then occurring between the brake pedal and the primary piston.

An essential aspect in the provision of pedal-counterforce simulation means is the so-called “pedal feel”. This is understood to be the nature of the deployment and the level of the forces by which a brake actuation is opposed by the pedal-counterforce simulation means in relation to the braking that is achieved. Normally, the pedal feel has to be set according to vehicle manufacturers' specifications. This makes it necessary to take precautions for a possible influencing of the operating behaviour of the pedal-counterforce simulation means.

### BRIEF SUMMARY OF THE INVENTION

An object of the present invention is to provide a braking-force generator, of the type designated at the outset, which has a high reliability with a relatively simple and inexpensive structure, and in which the behaviour of the pedal-counterforce simulation means can be modified.

This object is achieved by a braking-force generator, having the features designed at the outset, in which the pedal-counterforce simulation means can be coupled to the force input element via a hydraulic system, the hydraulic system being realized with a throttle valve which is provided in the hydraulic connection to the pedal-counterforce simulation means and can be optionally switched into different throttle valve positions.

The provision of a throttle valve, which can be switched into different throttle valve positions, in a hydraulic connection between the pedal-counterforce simulation means and the actuating-force generation means can substantially influence the pedal feel. Depending on the selected throttle valve position, the driver perceives, on the brake pedal, a greater or lesser resistance to a pedal actuation, this making it possible, for example, to simulate a sporty or comfortable behaviour of the braking system.

According to a development of the invention, provision may be made whereby the throttle valve is provided in a hydraulic line between a hydraulic chamber of the actuating-force generation means and the pedal-counterforce simulation means, preferably between the pedal-counterforce simulation means and a pilot-valve arrangement. The pilot-valve arrangement may be provided, for example, to fully decouple the pedal-counterforce simulation means from the actuating-force generation means. This may be necessary, for example, if parts of the vehicle braking system have failed, so that, in an emergency operating mode, the pedal actuation force has to be used fully to generate an actuation force on the primary piston. According to an advantageous development of the invention, the throttle valve and the pilot-valve arrangement may also be realized as a common function unit.

Provision may be made, in the case of an embodiment of the invention, whereby the throttle valve can be shifted into a certain, essentially unchanged, throttle position according to a predetermined throttle behaviour. It is thus possible, for example during fitting of the braking-force generator, to set a certain throttle valve position which is then lastingly maintained. As an alternative to this, provision may be made whereby the throttle valve can be activated electromagnetically, the throttle valve position being variable according to the electromagnetic activation. It is thereby possible for the throttle valve to be activated according to certain operating parameters of the vehicle. Thus, for example, the throttle valve position can be adjusted according to a switch position of a certain switch which, for example, gives the driver the choice between a sporty and a comfortable brake tuning. Certain vehicle dynamics parameters may also affect the throttle valve position.

According to an exemplary embodiment of the invention, the throttle valve has a valve casing and a valve piston displaceably guided in the valve casing. The valve piston is preferably guided in a pressure-relieved state in the valve casing. This means that the valve piston does not have to work against applied hydraulic pressures in the case of an electromagnetic actuation. In this connection, provision may furthermore be made according to the invention whereby the valve casing accommodates a energizable coil, and the valve piston is realized integrally with an armature element or is coupled to same for the purpose of common movement.

A development of the invention makes provision whereby the valve casing has a throttle aperture which is located in the fluidic connection between the actuation-force generation means and the pedal-counterforce simulation means, and the valve piston has a throttle portion which can be positioned in dependence on the throttle valve position in the throttle aperture. The throttle aperture is preferably conical in form. Furthermore, in the case of a development of this embodiment, provision may be made whereby the valve piston is biased by a spring element into the throttle aperture, preferably into a throttle valve position of maximum throttle effect. It is thereby possible to achieve the situation in which a sufficient release of the throttle aperture, permitting a perceptible activation of the pedal-counterforce simulation means, is only achieved following energizing of the coil.

As an alternative to the previously described embodiment, provision may also be made, according to the invention, whereby the valve piston is cylindrical in form and is accommodated in a sealed manner in a valve bore in the valve casing or in the basic casing, the valve bore being located in the fluidic connection between the actuation-force generation means and the pedal-counterforce simulation means, and the valve piston is realized with a throttle groove which, in dependence on the throttle valve position, provides a throttled connection between the actuation-force generation means and the pedal-counterforce simulation means. Depending on the position of the valve piston within the valve bore, the effective diameter for the hydraulic connection between the actuation-force generation means and the pedal-counterforce simulation means can thus be adjusted and, consequently, the throttle effect of the throttle valve can also be adjusted. Provision may preferably be made, in this context, whereby the throttle groove is provided with a tapering profile.

A development of this embodiment makes provision whereby the valve piston is biased by a spring element into a predetermined throttle valve position, preferably into a throttle valve position of minimum throttle effect.

The invention furthermore relates to a braking system for a motor vehicle, comprising a braking-force generator of the previously described type.

Other advantages of this invention will become apparent to those skilled in the art from the following detailed description of the preferred embodiment, when read in light of the accompanying drawings.

### BRIEF DESCRIPTION OF THE DRAWINGS

FIG. 1 shows a schematic general representation of the braking-force generator according to the invention and of the vehicle components coupled to same;

FIG. 2 shows an enlarged schematic detailed sectional view of the area of the braking-force generator that includes the throttle valve;

FIG. 3 shows a representation according to FIG. 2 with a slight modification of the embodiment of the throttle valve according to FIG. 2;

FIG. 4 shows a further embodiment of a throttle valve in a representation corresponding to FIG. 2, and

FIG. 5 shows the embodiment of the throttle valve according to FIG. 4 in a position of maximum throttle effect.

### DETAILED DESCRIPTION OF THE INVENTION

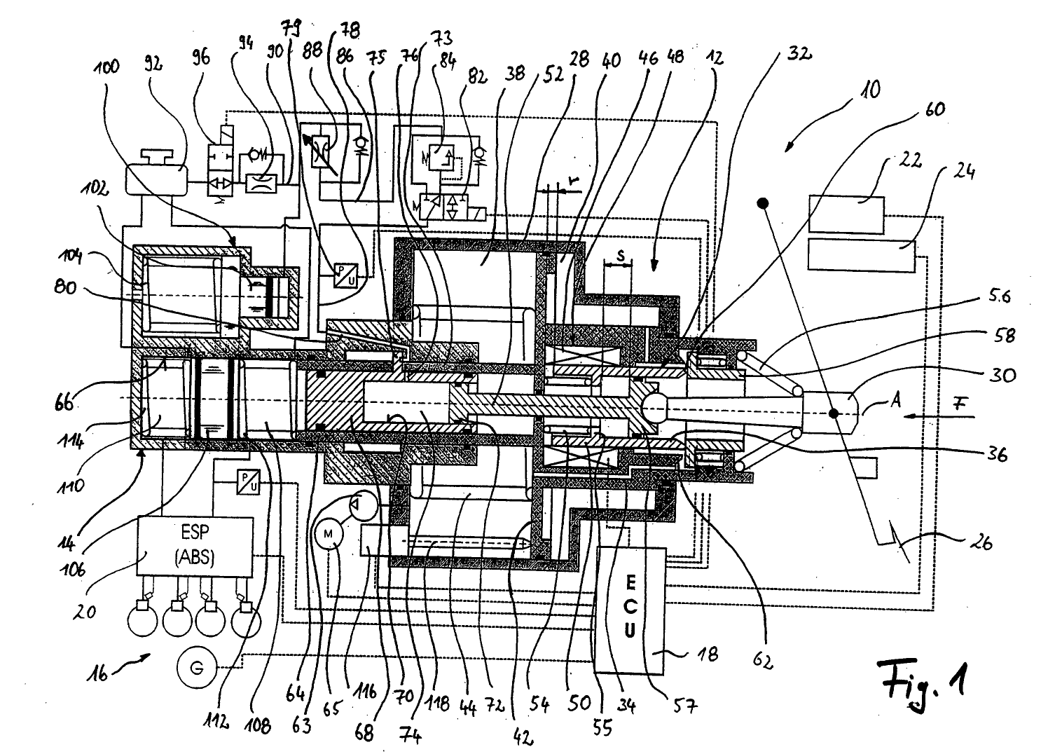

In FIG. 1, a braking system according to the invention is represented schematically and denoted generally by the reference 10. This braking system comprises a braking-force generator 12, and a master brake cylinder 14 which is coupled to the latter. The master brake cylinder 14 communicates, in conventional manner, with a braking system 16, which controls via an electronic control unit 18. In this case, the electronic control unit 18 receives signals from various feedback-control systems within the vehicle, such as, for example, an electronic stability program and an anti-lock system 20, an automatic cruise control system 22 or the like. The signals flowing from these programs to the electronic control unit 18 are evaluated and used for activating the braking-force generator 12 according to the invention. In addition, the electronic control unit 18 receives signals from a rotational-angle sensor 24, which detects the current position of a brake pedal 36 and thereby provides a signal corresponding to the current pedal actuation. According to the signal characterizing the current pedal actuation, the electronic control unit 18 activates the braking-force generator 12, the structure and functioning of which are explained in the following.

In respect of its basic structure, the braking-force generator 12 according to the invention consists of two modules, namely, on the one hand, of the master brake cylinder 14 and, on the other hand, of a braking-force generator casing 28 in which the master brake cylinder 14 is inserted and to which it is detachably connected. A force input element 30, realized in the form of a bar, extends into the, in FIG. 1, right-hand portion of the braking force generator 12, particularly of the casing 28. A control valve 32 is provided in this region. The control valve 32 comprises a control-valve casing 34, which is displaceable relative to the casing 28. Provided within the control-valve casing 34 is a valve sleeve 36 which is displaceable relative to the latter.

The braking-force generator 12 furthermore comprises a chamber arrangement which is disposed within the casing 28 and comprises a vacuum chamber 38 and a working chamber 40, which are separated from one another in a tight manner by a movable wall 42. The movable wall 42 is coupled to the control-valve casing 34 for the purpose of common movement.

An electrically controllable coil 46 of an electromagnetic actuator 48 is disposed in the control-valve casing 34. The actuator 48 additionally comprises a magnetic armature 50, which is displaceable relative to the control-valve casing 34 and to the coil 46 in the direction of the longitudinal axis A of the braking-force generator 12 and is realized integrally with the valve sleeve 36. Furthermore, the armature 50, and the valve sleeve 36, is provided with an axial through-bore, in which a transmission piston 52 extends in a movable manner. The armature 50 is biased, by means of a spring 54, into the position shown in FIG. 1. The spring 54 bears, with its one end, on the movable wall 42 and, with its other end, on an inner flange 55 on the armature 50. At its end which is on the right in FIG. 1, the transmission piston 52 has a receiving piston portion 57 which workingly accommodates the force input element 30.

Provided between the right end face of the flange 55 and the left end face of the receiving piston portion 57 is a safety clearance s, which must first be overcome before the receiving piston portion 57 comes into abutment with the flange 55. Furthermore, provided between the left end face of the armature 50 and the portion of the movable wall 42 opposite said armature is a further clearance r, which must first be overcome before a mechanical coupling of armature 50 and movable wall 42, and thus of armature 50 and primary piston 64, exists.

The valve sleeve 36, the control-valve casing 34, and a valve element 58 which is displaceable relative to said valve sleeve and control-valve casing constitute the actual pilot valve 22. In the state shown in FIG. 1, the valve sleeve 36 bears, with its sleeve sealing seat 60 which faces the valve element 58, on the valve element 58. Furthermore, in this state a casing sealing seat 62 realized on the control-valve casing 34 is raised from the valve element 58. In the sate shown in FIG. 1, the control valve 32 connects the vacuum chamber 38 to the working chamber 40. The vacuum chamber 38 is in this case coupled to a vacuum source, namely to a separately realized vacuum pump 63 which, activated by means of the electronic control unit 18, is driven by an electric motor 65. The force input element is biased, by means of a return spring 56, into the position shown in FIG. 1.

The transmission piston 52 extends, with its end which is on the left in FIG. 1, into a primary piston 64, which is realized with an axial through-bore. The primary piston 64 is guided, in a sealing manner, in a bore 66 which is open on one side and which is realized in the cylinder casing 14. An actuating piston 68 is displaceably guided in the through-bore of the primary piston 64. The actuating piston 68 likewise has a bore 70 which is open on one side, and which is closed by a separating piston 72 which is displaceable in said bore 70 and is integrally realized on the left end of the transmission piston 52. The separating piston 72, with the actuating piston 68, encloses a hydraulic chamber 74. Via a stop pin 75, which is guided through an oblong slot 73 provided in the primary piston 64, the actuating piston 68 bears on a diameter step within the cylinder casing 14. It is thereby prevented from axial movement to the right in FIG. 1.

The hydraulic chamber 74 is fluidically connected, via a connecting channel 76, to a fluid channel 80 realized in the cylinder casing 18. The fluid channel 80 leads, via a fluid line 78 having a pressure-measuring means 79 coupled to the electronic control unit 18, to an electromagnetic pilot valve arrangement 82, which is shown schematically. This pilot valve arrangement can be activated by the electronic control unit 18 and, in the state shown in FIG. 1, is in its passive position, which it assumes automatically owing to a biasing spring. Upon energizing of the pilot valve arrangement 82 through the electronic control unit 18, the pilot valve arrangement 82 can be brought into its active position. The pilot valve arrangement 82 is coupled to two line branches. In the passive position, the fluid line 78 is fluidically connected to a pressure-limiting valve 84 which blocks a fluid flow out of the hydraulic chamber 74 until a pressure threshold has been reached at which the pressure-limiting valve 84 opens. In the active position, the pilot valve arrangement 82 permits a fluid flow out of the hydraulic chamber 74, via the fluid line 78, into a fluid line 86 adjoining the pilot valve arrangement 82. Disposed in the fluid line 86 is a throttle means 88, which can be activated electromagnetically and the structure and functioning of which are to be explained in the following. Furthermore, a line branch 90 branches off from the fluid line 86 to an unpressurized hydraulic fluid reservoir 92. A throttle means 94 and a separating valve arrangement 96 are disposed before the hydraulic fluid reservoir 92. The separating valve arrangement 96 is biased, by means of a biasing spring, into the passive position shown in FIG. 1, in which it fluidically connects the fluid line 86 to the hydraulic fluid reservoir 92. The separating valve arrangement 96 can be switched over into its active position, in which it fluidically separates the fluid line 86 from the hydraulic fluid reservoir 92, by being energized through the electronic control unit 18.

The fluid line 86 opens out, finally, into a pedal-counterforce simulation means 100. The pedal-counterforce simulation means 100 is integrally realized in the cylinder casing of the master brake cylinder 14. It comprises a simulation piston 102, which is displaceable against the resistance of a simulation spring 104 and thereby opposes a movement of the transmission piston 52, resulting from an actuation of the brake pedal 26, with a resistance.

It must also be added that non-return valves which, in certain operating situations, block an unwanted fluid flow to the hydraulic chamber 74, are respectively disposed in the fluid line 86, in parallel to the pressure-relief valve 84 and in parallel to the throttle means 88 and, in the line branch 90, in parallel to the throttle means 94.

Returning to the structure of the braking-force generator 12 according to the invention, as it is represented in FIG. 1, it can be seen from this representation that, in addition to the primary piston 64, a secondary piston 106 is also movably accommodated in the cylinder casing 14. The primary piston 64, together with the boundary wall of the bore 66 and the secondary piston 106, and the end of the actuating piston 68 that is on the left in FIG. 1, delimits a primary pressure chamber 108. The secondary piston 106, together with the boundary wall of the bore 66, delimits a secondary pressure chamber 110. The primary piston and secondary piston are biased, by means of return springs 112 and 114, into the position shown in FIG. 1.

Finally, a position sensor 116 is also shown in FIG. 1. The position sensor 116 has a tappet 118, which is spring-biased to the right in FIG. 1 and which, with its free end, bears continuously on the movable wall 42 and detects its current position.

The functioning of the braking-force generator 12 according to the invention is to be explained in the following with reference to FIG. 1.

Following an actuation of the brake pedal 26, the force input element 30 is subjected to the force F and displaced along the longitudinal axis A of the braking-force generator, relative to the initial position shown in FIG. 1. If all components are functioning fully—i.e., in a normal operating situation—the brake-pedal actuation is detected directly by the rotational-angle sensor 24 shown in FIG. 1, and forwarded to the electronic control unit 18. The latter activates the coil 46 and energizes it according to predefined characteristics and, possibly, taking account of further parameters, for example from the stability program and the anti-lock system 20 or the cruise control means 22. The energizing of the coil 46 causes a magnetic field to be built up in the latter, said magnetic field drawing the armature 50 into the coil, to the left in FIG. 1. In this case, the valve sleeve 36 is drawn along by the armature 50. The valve element 58 moves with the valve sleeve 36 until it comes into abutment on the casing sealing seat 62. The sleeve sealing seat 60 is then raised from the valve element 58. As a consequence, the vacuum chamber 38 is isolated from the working chamber 40, and the working chamber 40 is connected to the ambient atmosphere. An above-atmospheric pressure, which results in a displacement of the control-valve casing 34 against a force of a return spring 44 and also, consequently, in a displacement of the primary piston 64 and of the secondary piston 106, builds up in the working chamber 40. As a result, there is respectively built up, in the primary pressure chamber 108 and in the secondary chamber 110, a brake pressure which is used, in a vehicle braking system connected to the braking-force generator 12, to brake the vehicle. The movable wall 42 moves with the control-valve casing 34 until both sealing seats, namely the sleeve sealing seat 60 and the casing sealing seat 62, are again in abutment on the valve element 58. In this state, the system is in equilibrium, and no further change occurs without external action.

As previously explained, the actuation of the control valve 32 is effected through a displacement of the armature 50, which is moved, through the magnetic force generated in the coil 46, along the longitudinal axis A. In the actuated state shown in FIG. 1, however, the movement of the force input element 30 and the force F which initiates this movement are not transmitted to the armature 50. Rather, this movement of the force input element 14 is transmitted to the transmission piston 52. The transmission piston 52 is consequently displaced within the primary cylinder 64, in particular within the bore 70, open on one side, of the actuating piston 68, and in this case moves the separating piston 72 to the left in FIG. 1, the actuating piston 68 remaining in its position relative to the casing 28 owing to the hydraulic pressure prevailing in the primary pressure chamber 108.

The movement of the separating piston 72 causes hydraulic fluid to be delivered out of the hydraulic chamber 74, via the connecting channel 76 and the fluid channel 80, to the electromagnetic pilot valve arrangement 82. As a result of the detected pedal actuation, the electromagnetic pilot valve arrangement 82 is switched by the electronic control unit 18 into its active position, in which it allows a fluid flow out of the hydraulic chamber 74. Furthermore, owing to the detected pedal actuation, the separating valve arrangement 96 is switched by the electronic control unit 18 into its active position, in which it blocks a fluid flow out of the hydraulic chamber 74 into the fluid reservoir 92. Consequently, the hydraulic fluid forced out of the hydraulic chamber 74 cannot flow into the hydraulic fluid reservoir 102, but is delivered, against the resistance of the pedal-counterforce simulation device 100, into the latter. The simulation piston 102 is then displaced, with the simulation spring 104 being compressed. The behaviour of the pedal-counterforce simulation means 100 is affected by the position of the controllable throttle valve 88.

If the brake pedal is released again by the driver, the system moves back into the position shown in FIG. 1. Owing to the action of the pedal-counterforce simulation means 100 and further return springs, the force input element 30 is then moved back into its initial position. This return movement is effected, with hysteresis, in dependence on the position of the throttle valve 88.

The phases, described above, of the braking-force generation are always effected with maintenance of the safety clearance s, apart from small fluctuations due to lag. The safety clearance r, however, is changed owing to the displacement of the armature caused by the actuator, and possibly even used up in the case of very forceful braking.

During the activation of the actuator 48, the current position of the movable wall 42 is permanently detected by the electronic control unit 18, via the position sensor 116. The actual position of the control-valve casing 34 can thereby be detected and compared with a setpoint position predetermined through the pedal actuation. In the case of a discrepancy of the actual and setpoint positions, for example owing to an alteration of the pedal position by the driver or owing to other external influences, the electronic control unit 18 effects corrective actuation of the actuator 48. In the case of an emergency braking, in which the brake pedal 26 is depressed rapidly and with great actuating force by the driver, the electronic control unit 18 can also effect disproportionately strong energizing of the actuator 48, in order rapidly to build up a high pressure difference in the chamber arrangement and consequently to generate, with the braking-force generator 12, a braking force that is sufficiently large for emergency braking.

The preceding description shows that, in normal operation, the actuating force F exerted on the force input element effects only a displacement of the transmission piston 52 and, as a result of a hydraulic transmission, a movement of the simulation piston 102, but has no direct effect whatsoever on the components of the control valve 32. Rather, the actuating force which displaces the primary piston 64 is initiated through activation of the actuator 48 and displacement of the armature 50, as a result of which the control valve 32 is actuated, in order to achieve a pressure difference in the chamber arrangement. Owing to this pressure difference, the control-valve casing 34 and, with the latter, the primary piston 64 and the secondary piston 106, are displaced.

The following describes an emergency operating situation in which the braking-force generator 12 according to the invention continues to function despite a defect on one or more components:

An emergency operating situation occurs, for example, if the coil 46 is no longer properly activated. This may be due to the fact, for example, that the rotational-angle sensor 22 is defective, or that a defect occurs in the on-board power supply of the vehicle. This defect results in the electronic control unit 18 failing to bring the pilot valve arrangement 82 into its active position. In the case of such a defective operating state, the control valve 32 can no longer be actuated via the actuator 48. Nevertheless, a sufficiently good braking effect can still be achieved with the braking-force generator 12 according to the invention. Upon actuation of the brake pedal, the force input element 30 is displaced to the left in FIG. 1. As a result, the transmission piston 62 is displaced to the right in FIG. 1, along the longitudinal axis A. Since, however, the pilot valve arrangement 82 is not activated by the electronic control unit 18 and thus remains in the passive position shown in FIG. 1, the hydraulic fluid contained in the hydraulic chamber 74 cannot escape. Owing to the non-compressibility of the hydraulic fluid, the head of liquid contained in the hydraulic chamber 74 first produces a direct hydromechanical force coupling between the transmission piston 52 and the actuating piston 68, which, via the connecting pin 75, finally displaces the primary piston 64 in the cylinder casing 14. The brake pedal actuation is thus first transmitted directly, and without overcoming of the idle clearance s, to the primary piston 64, this resulting in a reliable and rapid response of the braking system 10 in the case of emergency operation.

In such an emergency operating situation, the brake pedal actuation also results in a large increase in pressure within the hydraulic chamber 74. If the pressure prevailing within the hydraulic chamber 74 exceeds the pressure threshold value set by the pressure-limiting valve 84, hydraulic fluid can escape from the hydraulic chamber 74, via the pilot valve arrangement 82, the pressure-limiting valve 84 and the separating valve 96, into the reservoir, due to the action of the force F on the force input element 30. This results in a displacement of the transmission piston 52 relative to the actuating piston 68, the pressure threshold value set by the pressure-limiting valve 84 continuing to prevail as a pressure in the hydraulic chamber 74. Upon the force input element 30 being further subjected to strong force, causing the pressure threshold value to be exceeded, the transmission piston 52 moves further relative to the actuating piston 68, and also further relative to the valve sleeve 36 that is not actuated owing to the failure of the actuator. In this case, the safety clearance s is overcome until, finally, the receiving piston portion 57 comes into abutment on the flange 55. The transmission piston 52, and therefore also the force input element 30, are then workingly connected to the valve sleeve 36. Consequently, a further displacement of the force input element 30 to the left in FIG. 1 also results in a displacement of the valve sleeve 36, causing the sleeve sealing seat 60 to be raised from the valve element 58. There consequently arises the previously described situation, in which a pressure difference can develop between the vacuum chamber 38 and the working chamber 40. If the vacuum source coupled to the vacuum chamber is still functioning correctly, this mechanical displacement of the valve sleeve 36 causes a pressure difference to be built up between the working chamber 40 and the vacuum chamber 38, said pressure difference causing a displacement of the movable wall 42 and, consequently, a displacement of the primary piston 68. In this state, in which the actuator 48 has failed, the control valve 32 is therefore actuated mechanically, after overcoming of the safety clearance s.

In the emergency operating situation described above, in which only the actuator, but not the vacuum source, has failed, the hydromechanical coupling of the actuating piston 68 and the transmission piston 52 first enables a direct minimum braking action to be achieved, which is determined by the level of the pressure threshold value. Subsequently, following overcoming of the safety clearance s, a pneumatic braking-force generation can be achieved in the conventional manner. This also applies to the case in which the vacuum source has also failed, but there is still a sufficient vacuum in the vacuum chamber 38 to achieve brake boosting. It is thus possible, for example, still to perform three to four braking operations, even if the vacuum source has failed, until a sufficient pressure difference can no longer be set between the vacuum chamber 38 and the working chamber 40.

Even in emergency operating situations, in which the vacuum source has also failed and the available vacuum has been “used up”, the braking force generator 12 according to the invention also enables purely mechanical braking to be performed. Again, in such cases, the safety clearance s is first used up following exceeding of the pressure threshold value in the hydraulic chamber 74, causing the flange 55 and the receiving piston portion 57 to come into mutual abutment, and thus resulting in a mechanical coupling of the valve sleeve 36 and the force input element 30. Subsequently—as already described above—upon further displacement of the force input element 30 to the left in FIG. 1, the valve sleeve 36 is displaced to the left in FIG. 1, with the result that the clearance r is also used up. Finally, through the receiving piston portion 57 and the valve sleeve 36, the valve sleeve 36 comes, with its end face that is on the left in FIG. 1, into mutual abutment with the movable wall 42, resulting in a direct mechanical coupling between the force input element 30 and the primary piston 64 that is coupled to the movable wall. A further displacement of the force input element 30 to the left in FIG. 1 in the case of such a mechanical coupling therefore results in a direct displacement of the primary piston 64 and, consequently, in a direct transmission of the pedal actuation force to the primary piston 64.

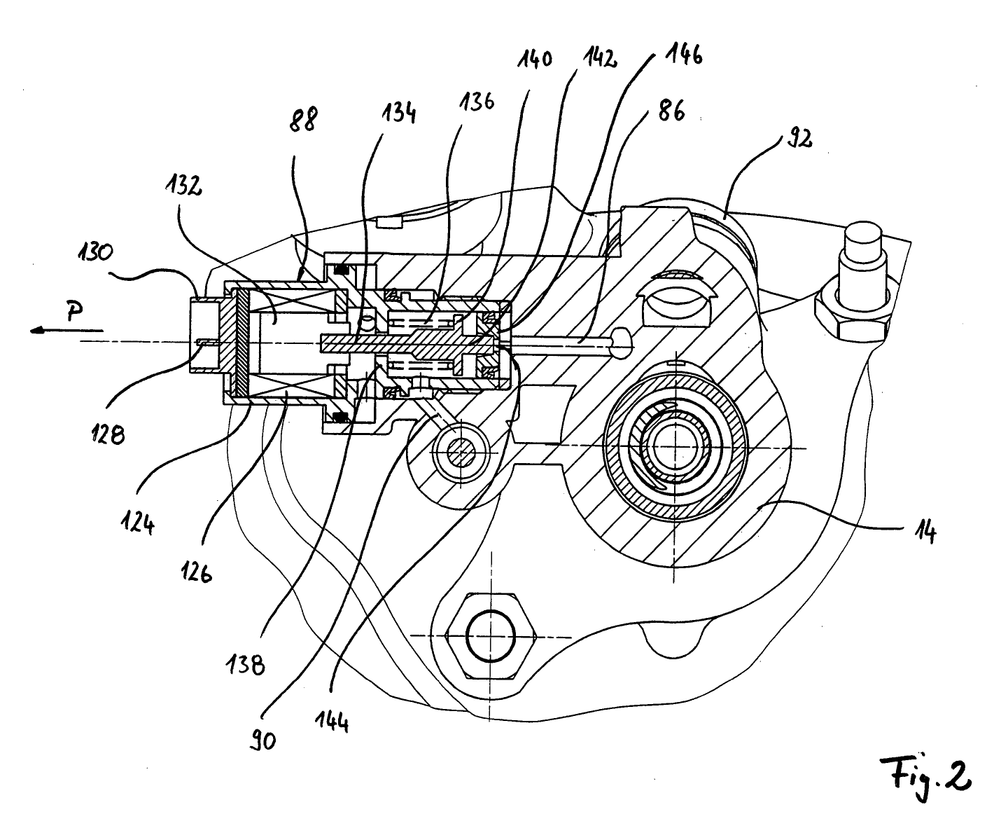

FIG. 2 shows a sectional detailed representation of the throttle valve 88. The throttle valve 88 is accommodated in the cylinder casing 14, in a stepped bore. It comprises a valve casing 124, in which a coil 126 is accommodated. The coil 126 can be energized via contacts 128 of a plug-in connector 130. An armature 132 is movably guided in the coil 126. The armature 132 is coupled to a valve piston 134 for the purpose of common movement. The armature 132 can thus be displaced together with the coil 126 within the valve casing 124. The assembly consisting of the armature 132 and the valve piston 134 is biased by a return spring 136 into the position shown in FIG. 2. In this case, one end of the return spring 136 is applied to a support flange 138 of the valve casing 124, and its opposite end is applied to an abutment flange 140 which is realized on the valve piston 134. The valve piston 134 additionally has a pin-type throttle portion 142 which, in FIG. 2, projects into a conical throttle aperture 144. The conical throttle aperture 144 is realized in a throttle washer 146, which is accommodated in a firm, sealed manner in the valve casing 124.

In the position shown in FIG. 2, the throttle portion 146 largely closes the throttle aperture 144 completely, with the result that there is no fluidic connection between the hydraulic chamber 74 and the pedal-counterforce simulation means 100. If, however, the coil 126 is energized, the armature 132 is displaced to the left, according to the arrow P in FIG. 2. The valve piston 134 is then carried along with it, with the result that the throttle portion 146 also moves out of the throttle aperture 144, according to the displacement of the armature 132, against the action of the return spring 136. A throttled fluidic connection between the fluid chamber 74 and the pedal-counterforce simulation means 100 thereby becomes possible. The degree of throttle effect is determined by the position of the throttle portion 146 within the throttle aperture 144.

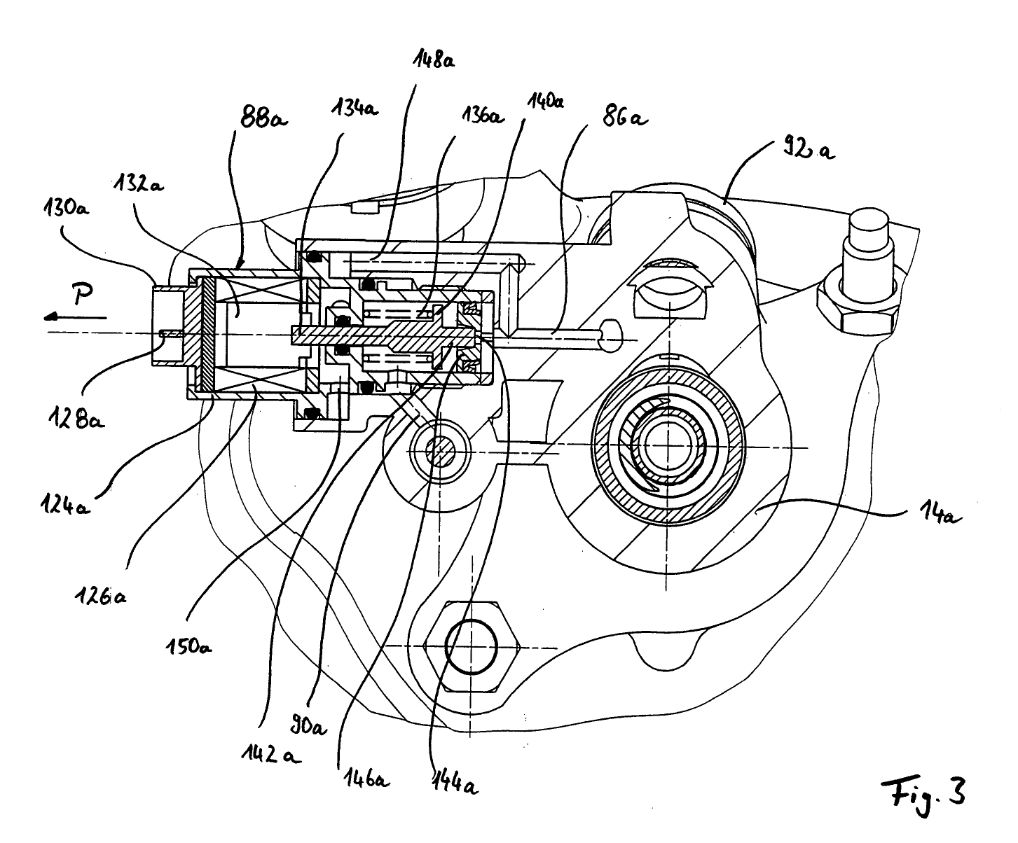

FIG. 3 shows an embodiment of the throttle valve 88 according to the invention which is slightly modified compared with FIG. 2. To facilitate description and avoid repetitions, the same references as used in the description of FIG. 2, but with a lower-case “a” suffix, are used for components which are of the same type or have the same function.

The embodiment according to FIG. 3 differs from the embodiment according to FIG. 2 in that the valve piston 134a is guided in the cylinder casing 14a in a pressure-balanced state. This is achieved in that the hydraulic fluid from the hydraulic line 86a is also routed, via a bypass line 148a and the aperture 150a, into the area of the armature 132a, with the result that, ultimately, the valve piston 134a can be displaced in a pressure-balanced state along the arrow P. The ability of the valve piston 134a to be adjusted via the coil 126a is thereby improved, because the hydraulic pressure applied via the hydraulic line 86a no longer loads the valve piston 134a on the front face.

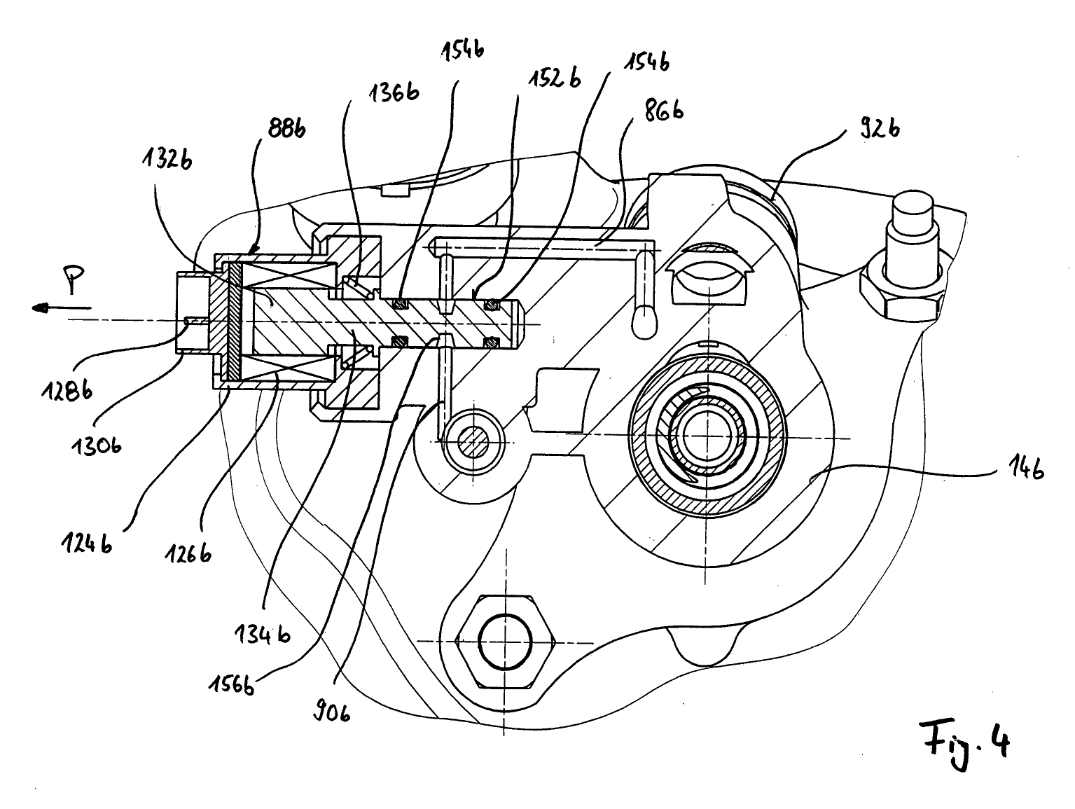

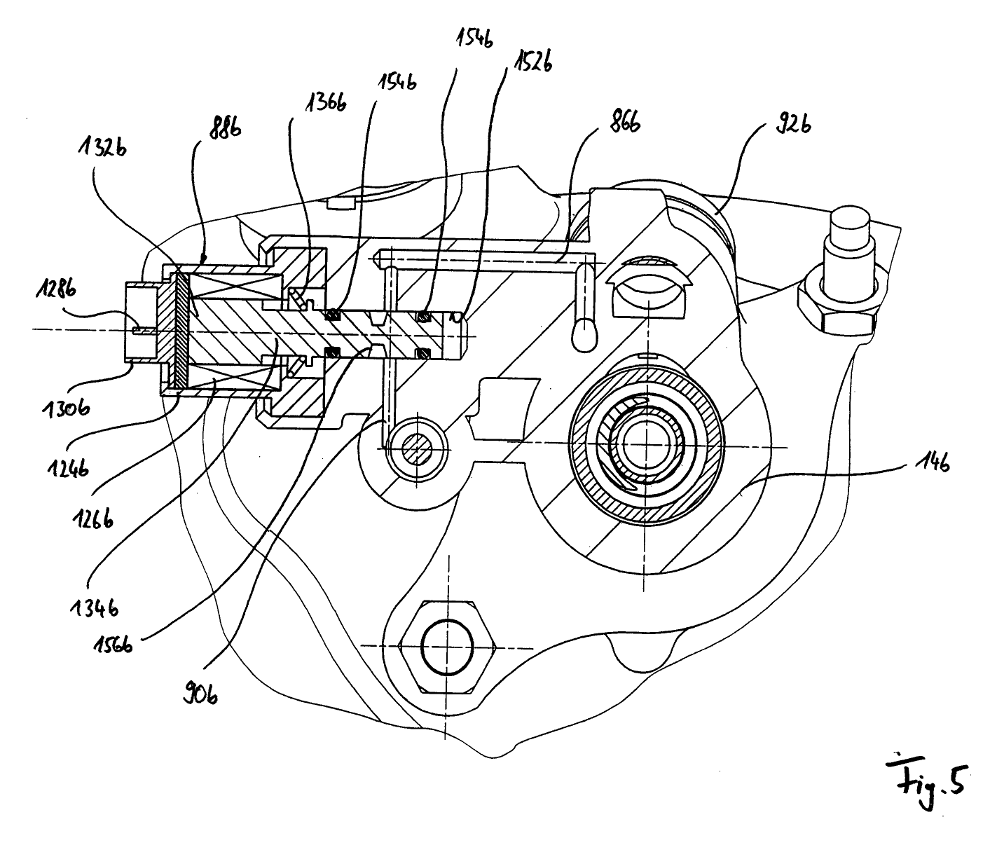

Finally, FIGS. 4 and 5 show a further exemplary embodiment for the. throttle valve according to the invention. Again, the same references as used in FIG. 1, but with a lower-case “b” suffix, are used for components which are of the same type or have the same function.

In the exemplary embodiment according to FIG. 4, the valve piston 134b is guided in a sealed manner in a valve bore 152b within the cylinder casing 14b, ring seals 154b being let into the outer circumference of the valve piston 134b. A full-perimeter throttle groove 156b, which tapers radially inwards in the longitudinal section, according to FIG. 4, of the valve piston 134b, is provided between the two ring seals 154b. The valve piston 134b is realized integrally with the armature 132b. The component consisting of the valve piston 134b and the armature 132b is biased by the return spring 136b into the position shown in FIG. 4, in which the throttle groove 156b provides a connection, that is largely free from throttle action, between the two hydraulic lines 86b and 90b. Energizing of the coil 126b, however, causes the component consisting of the armature 132b and the valve piston 134b to be displaced to the left, according to the arrow P in FIG. 4, against the action of the return spring 136b. This can be seen in FIG. 5. In FIG. 5, the position of the valve piston 134b is shown at maximum throttle effect. The effective cross-section through which hydraulic fluid can flow to and fro between the lines 86b and 90b, via the throttle groove 156b, has been substantially reduced compared with the position from FIG. 4.

The pedal feel perceived by a driver in actuations of a brake pedal of a vehicle braking system equipped with the braking-force generator according to the invention can be substantially influenced by means of the different embodiments of throttle valves according to the invention, shown in FIGS. 2 to 5. Depending on the position of the respective throttle valve, the pedal-counterforce simulation means is hydraulically activated with greater or lesser throttle, which allows the driver to perceive a greater or lesser resistance when depressing the brake pedal, and results in a greater or lesser hysteresis when the brake pedal is released. The throttle valve may be set in advance or, alternatively, also activated differently in dependence on certain operating situations of the vehicle or as selected by the driver.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. Braking-force generator for a hydraulic vehicle braking system, comprising
a force input element which can be coupled, or is coupled, to a brake pedal and is displaceable in a basic casing of the braking-force generator,
a master brake cylinder, in which a primary piston is displaceably guided, the primary piston delimiting, with the master brake cylinder, a primary pressure chamber for generating a hydraulic braking pressure,
a pedal-counterforce simulation means that can be coupled to the force input element,
a pedal-actuation detection means for detecting a pedal actuation, and
an actuating-force generation means for exerting an actuating force on the primary piston,
wherein the pedal-counterforce simulation means can be coupled to the force input element via a hydraulic system, the hydraulic system being realized with a throttle valve which is provided in the hydraulic connection to the pedal-counterforce simulation means and can be optionally switched into different throttle valve positions.

2. Braking force-generator according to claim 1, wherein the throttle valve is provided in a hydraulic line between a hydraulic chamber of the actuating-force generation means and the pedal-counterforce simulation means, preferably between the pedal-counterforce simulation means and a pilot-valve arrangement.

3. Braking-force generator according to either of claims claim 1,
wherein the throttle valve can be shifted into a certain, substantially unchanged, throttle position according to a predetermined throttle behaviour.

4. Braking-force generator according to claim 2, wherein the throttle valve can be activated electromagnetically, the throttle valve position being variable according to the electromagnetic activation.

5. Braking-force generator according to claim 4,
wherein the throttle valve an be activated according to certain operating parameters of the vehicle.

6. Braking-force generator according to any one of the preceding claim 1,
wherein the throttle valve has a valve casing and a valve piston displaceably guided, preferably in a pressure-relieved state, in the valve casing.

7. Braking-force generator according to claim 6,
wherein the valve casing accommodates an energizable coil, and in that the valve piston is realized integrally with an armature element or is coupled to same for the purpose of common movement.

8. Braking-force generator according to claim 6 either of claims 6, wherein the valve casing has a throttle aperture which is located in the fluidic connection between the actuation-force generation means and the pedal-counterforce simulation means, and in that the valve piston has a throttle portion which can be positioned in dependence on the throttle valve position in the throttle aperture.

9. Braking-force generator according to claim 8,
wherein the throttle aperture is conical in form.

10. Braking-force generator according to claim 8,
wherein the valve piston is biased by a spring element into the throttle aperture, preferably into a throttle valve position of maximum throttle effect.

11. Braking-force generator according to claim 6,
wherein the valve piston is cylindrical in form and is accommodated in a sealed manner in a valve bore in the valve casing or in the basic casing, the valve bore being located in the fluidic connection between the actuation-force generation means and the pedal-counterforce simulation means, and in that the valve piston realized with a throttle groove which, in dependence on the throttle valve position, provides a throttled connection between the actuation-force generation means and the pedal-counterforce simulation means.

12. Braking-force generator according to claim 11,
wherein the throttle groove is provided with a tapering profile.

13. Braking-force generator according to claim 11,
wherein the valve piston is biased by a spring element into a predetermined throttle valve position, preferably into a throttle valve position of minimum throttle effect.

14. Braking system for a motor vehicle, comprising a braking force generator according to claim 1.
